(19) United States
(12) Patent Application Publication
(10) Pub. No.: US 2011/0264562 A1
(43) Pub. Date: Oct. 27, 2011

(54) Estore One Click

(75) Inventor: Karl Joseph Borst, Woodbridge (CA)

(73) Assignee: GANZ, Woodbridge (CA)

(21) Appl. No.: 13/094,077

(22) Filed: Apr. 26, 2011

Related U.S. Application Data
(60) Provisional application No. 61/328,048, filed on Apr. 26, 2010.

(51) Int. Cl. G06Q 30/00

(52) U.S. Cl. 705/27.1

(57) ABSTRACT

Provided are a method and system that promote the conversion of visitors to a website into full members using a one click protocol. The method, which can be executed by a computer system, includes hosting a website on a server. User profiles are stored on the website, and the users include a first set of users who are full members and a second set of users who are not full members. Access is granted to an electronic store associated with the website, and a different version of the electronic store is accessible by the first and second sets of users. Members of the second set of users who purchase an item from the limited selection of items of the electronic store are converted into additional members, and subsequently granted access to portions of the website reserved for full members.

This application claims priority from provisional application No. 61/328,048, filed Apr. 26, 2010, the entire contents of which are herewith incorporated by reference.

### BACKGROUND

U.S. Pat. No. 7,425,169, filed Dec. 30, 2004 describes a system of interacting with a virtual representation of a real world product. According to this system, a user can buy a toy which is associated with a special code. The toy exists in the real world, and the code forms a key to the virtual world. The user enters the code on a website and enters the virtual world.

The virtual world provides activities and views with which the user can interact. The virtual world, as part of the interaction, provides a virtual replica of the actual toy. Users can carry out various activities on the website using their virtual version of the toy. For example, the user can form a house with rooms, interact with furniture in the house, purchase clothing and dress their virtual version of the toy, and other things. The user can also carry out activities to earn virtual cash, and purchase virtual items using that virtual cash.

The Webkinz dot corn website is an example of such a virtual world, and offers users the ability to access the website as free, or limited members and paid members through various scenarios. The free members receive less privileges on the Webkinz website then the paid members. One object of the free members is to give them a preview of what they get when they become paid members without requiring them to incur the full cost of becoming a paid member.

### BRIEF SUMMARY

According to one aspect, the subject application involves a method that includes hosting a website on a server, the website including a plurality of different interactive activities to be performed by users on the website. The plurality of interactive activities include interacting with virtual items on the website. The method also includes storing user profiles on the website, for the users of the website. Users of the website include a first set of users who have paid for membership access to the plurality of multiple different interactive activities on the website, and a second set of users who are free users who have not paid for access. The second set of users obtain access to fewer activities on the website than the first set of users. Access is granted to an electronic store associated with the website, such that when members of the first set of users who have paid for membership access request to visit the electronic store, the members of the first set of users are presented with an expansive selection of items available to be purchased, and when members of the second set of users who have not paid for access request to visit the electronic store, the members of the second set of users are presented with a limited selection of items available to be purchased. A number of the items in the limited selection is less than a number of the items in the expansive selection. The method also includes converting the free users who purchase a desired item selected from the limited selection of items into additional members of the first set of users. Subsequent to this conversion, the additional members of the first set of users are granted the membership access to the complete selection of items in response to a request by the additional members to visit the electronic store.

According to another aspect, the subject application involves a computer system that hosts a website that includes a plurality of interactive activities that a user can interact with using a virtual character. The computer system includes a server subsystem serving content, via the Internet, to allow remotely-located user computers to display the website to users accessing the website via the user computers. An account subsystem maintains user profiles for paid membership users who have paid to acquire a membership to the website. The paid membership users are granted access to the plurality of interactive activities on the website and free users that are not paid membership users are granted limited access to less than all of the plurality of interactive activities that are accessible by the paid membership users. An electronic-store subsystem hosts an electronic store offering for sale virtual items for use on the website. The paid membership users are granted access by the electronic-store subsystem to a paid user version of the electronic store offering an expansive selection of the virtual items for sale, and the free users are granted access by the electronic-store subsystem to a limited user version of the electronic store that offers fewer of the virtual items for sale than the paid user version of the store. The electronic-store subsystem limits the limited version of the electronic store to present users with a single view of the virtual items for sale in the limited version of the electronic store, to be purchased by the free users without allowing the free users to see any additional view of the virtual items in the limited version of the store, other than the single view, prior to purchasing the virtual items from the limited version of the electronic store. The free users are only allowed to purchase one of the virtual items from the limited version of the electronic store and are not allowed to do anything in the limited version of the electronic store other than purchase the one of the virtual items for sale, and the paid user version of the electronic store allows the users to view other views of the virtual items other than the single view prior to purchasing. The account subsystem indicates in a user profile for the free users who purchase an item from the limited version of the electronic store that the free users have become paid membership users with access to the paid user version of the store.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a flow diagram schematically depicting a method of converting a Tier 1 user to a full member in response to purchasing a virtual item from an estore according to a one click protocol;

FIG. 2 shows an illustrative example of a warning page;

FIG. 3 shows an alert screen indicating to a user attempting to enter the estore that the estore is not available in that user's geographic region based on information from the user's IP address;

FIG. 4 shows an illustrative example of a landing page of an estore where a limited number of virtual items are offered for sale to Tier 1 users;

FIG. 5 shows an illustrative embodiment of a payment page where a user is to enter payment information and agree to terms and conditions of sale to execute a purchase from an electronic store; and

FIG. 6 shows an illustrative embodiment of a summary page that includes a code uniquely identifying a purchased item and an adoption button leading to an adoption center where the purchased item can be adopted by the user.

### DETAILED DESCRIPTION

In a virtual presentation such as the Webkinz virtual world, for example, there is an electronic store or “estore” that allows users to purchase various things using either real credits (i.e., currency that is legal tender) or virtual credits (i.e., virtual currency that is not legal tender) received on the website.

The estore may accept various different kinds of currency.

According to an embodiment, the estore is enhanced in a way that is intended to improve the conversion rate of free, or so-called “Tier 1” members, who have not paid real credits to acquire full membership at the website with which the estore is associated, to full members, who have paid the real credits required to gain membership access to the website. This encourages users to become full members, thereby increasing the amount of revenue that can be obtained by the website.

Conventionally, users have had to go through quite a few number of steps to be able to purchase a virtual pet and become a full member. The experience is not only confusing but also frustrating. Some users have abandoned this conversion process entirely. In the Webkinz website, for example, users can purchase a virtual character from a virtual store. In response to a user purchasing a virtual character, a code is transmitted to the purchaser to be subsequently entered into the website for validation and registration purposes. Successfully validating the code allows the purchaser to become a full member. However, this defeats the purpose of allowing conversion between Tier 1 members and full members.

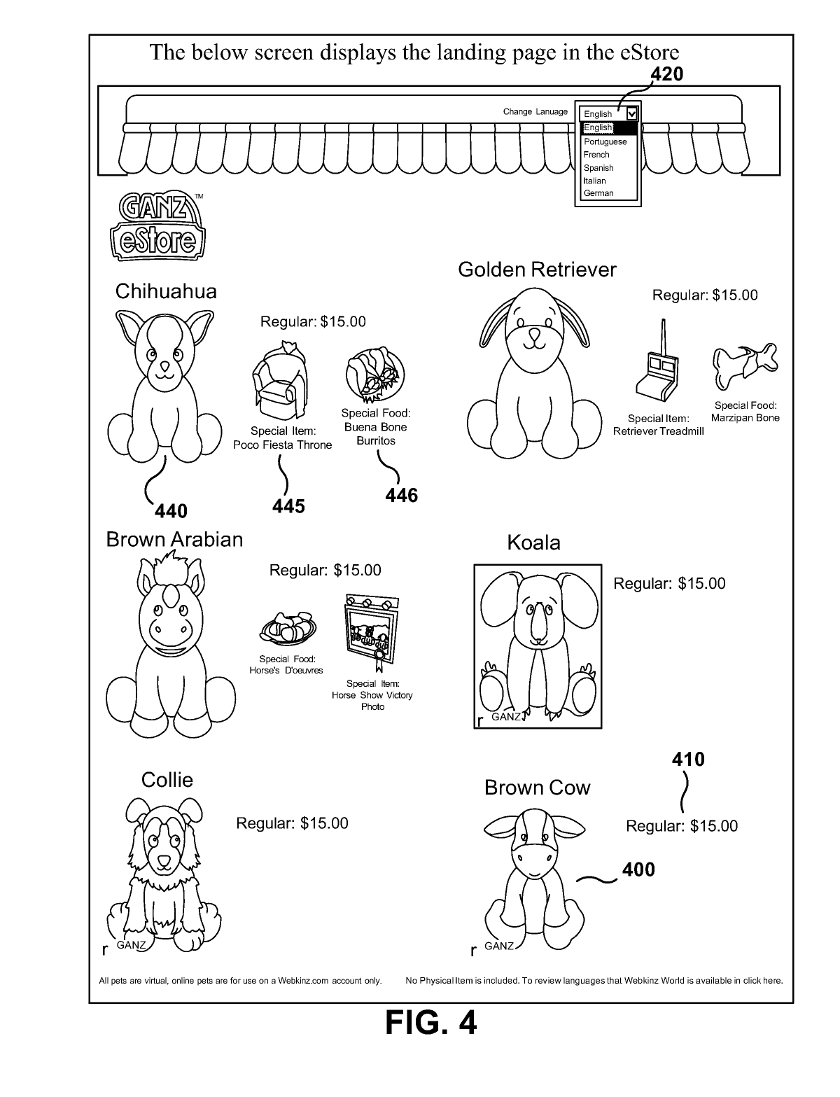

According to the present embodiment, a special limited version of the eStore simplifies and reduces the total number of steps required to purchase a virtual pet and redeem a pet code. The estore according to the present embodiment is implemented by an electronic-store subsystem described in detail below. An illustrative example of a landing page on the Webkinz website is shown in FIG. 4. As shown, the landing page displays the most popular pets, limited to a maximum of up to 20 items, however, as shown in FIG. 4, fewer items such as 6 or 8, for example, can be shown. The landing page of the estore is accessible to both Tier 1 users and full members, but the full members will be presented with a more-expansive offering of virtual items that can be purchased than the Tier 1 users.

Since Tier 1 users can access the landing page of FIG. 4, users are not required to create an account on the website as a prerequisite to making a purchase. However, users who do not have an account are only allowed to do certain things, here, only to purchase an item that is selected. According to certain embodiments, users are not allowed to do anything other than purchase said one of said items for sale. In this sense, when the users are Tier 1 users, they can purchase an item according to a “one click” protocol.

According to the one click protocol, products to be purchased by Tier 1 users from the landing page will not be added to a shopping cart of items to be purchased at a later time, such as when shopping is complete. Instead the user is asked to check out with the one product in response to selecting that one product as the virtual item to be purchased from the landing page. This creates an express check out situation, simplifying the demands on the Tier 1 to obtain the selected item and become a full member. All legal obligations are taken into account and user agreements, disclaimers reflect the one click protocol.

For purposes of this application, a Tier 1 user is defined as a user that has not purchased or adopted a pet that is to be controlled on the website. These users do not have full access to the website as other full members do. They have limited access to games, activities and other portions of the website, etc. . . . Things that Tier 1 users do not have access can be displayed, at least in part, on the website to provide Tier 1 users with a glimpse of the benefits of becoming a full user. However, a lock can be implemented to restrict the ability of Tier 1 users to perform certain actions so that the tier 1 users cannot carry out those actions, or at least not fully carry out such actions, on the website. According to alternate embodiments, Tier 1 users can optionally be granted access to a predetermined portion of an activity on an introductory, or trial basis to allow the Tier 1 users to experience what they are missing. However, the lock can cut off access to an activity once the Tier 1 users have progressed to a predetermined point. For example, the lock can be implemented to allow Tier 1 users to play levels 1 and 2 of a game on the website, but not levels beyond level 2. For other embodiments, icons to be selected to launch a game may be visible to Tier 1 users, but rendered inactive to prevent the Tier 1 users from participating in such a game. For such embodiments, the lock can be removed to grant full members, including Tier 1 users who are converted to full members, access to the restricted portions of the website.

As described herein, one of the advantages of the present system is that the non-paid users get a simplified version of the electronics store, as compared with the paid users. The nonpaid users are only allowed to do certain things, and many or all of those things are simplified towards an end goal that guides people to become a paid user.

In an embodiment, the Tier 1 users have not yet adopted a pet and are only allowed limited access to Webkinz world. Those Tier 1 users get only limited access to the e-store. According to an embodiment, those users are only allowed to see a single view, or optionally a lesser number of views full members are allowed to see, of any item that is for sale at the store. The Tier 1 users are presented with only a limited number of items they can purchase compared to the number of items available to be purchased by the full members. Tier 1 users can optionally be limited to only purchasing a single items selected from the landing page of FIG. 4 after seeing a single view of the selected item. According to the one click protocol, after the Tier 1 user purchases an item, the Tier 1 user is redirected automatically to an adoption center such as that described in U.S. Pat. No. 7,534,157 to Ganz, which is incorporated in its entirety herein by reference. Such an adoption center can be implemented by an adoption subsystem embodied by a suitably-programmed computer, and can cooperate with a similar account subsystem to allow the Tier 1 user making the purchase to create a user profile including an identification of the user as a full member. Having purchased an item, the Tier 1 user making the purchase thereafter will get access to the paid user version of the store, which has more functionality including a more-expansive, or optionally complete set of items for sale compared to the limited version of the estore including the landing page shown in FIG. 4, and the ability to view more thoroughly, and optionally a greater number of views of those items before purchase.

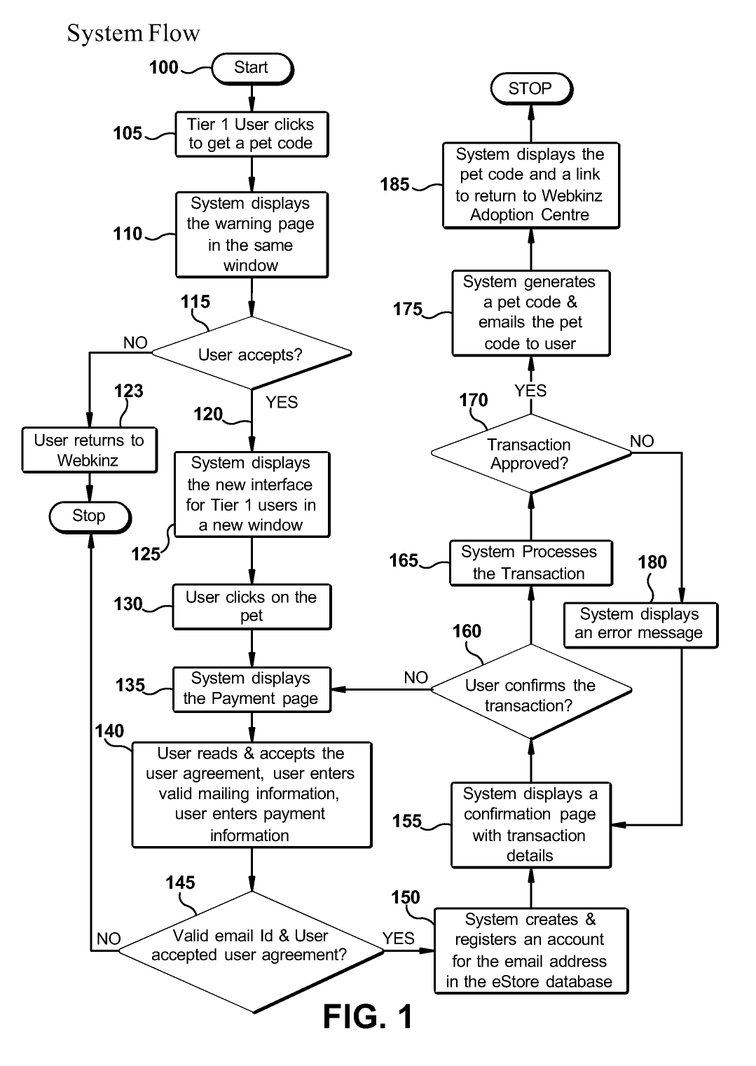

An embodiment of a method of converting a Tier 1 user to a full member proceeds according to the flow diagram of FIG. 1. FIG. 1 can be carried out for example on a server computer that hosts the website that is used according to Webkinz.com, for example.

In operation, the process starts at 100, with the Tier 1 user clicking on an icon on the website to enter the estore and obtain a pet code. This means that the user will be entering the estore.

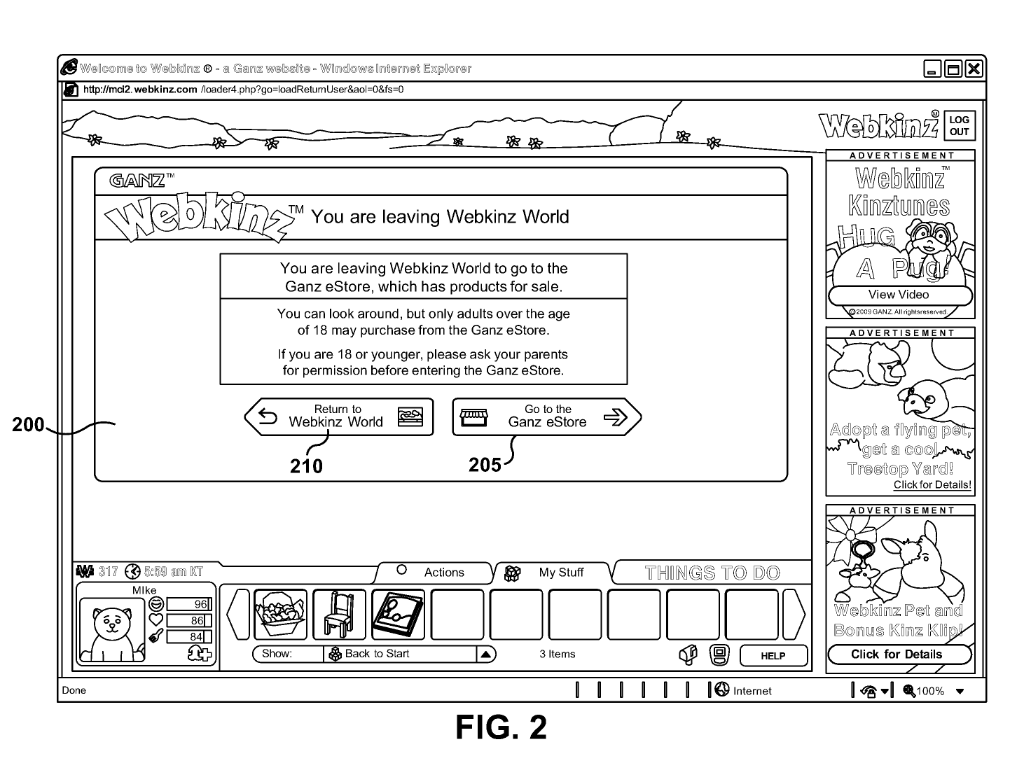

When a user selects to enter the eStore, the computer system transmits content over a communication network to allow a user computer to display a warning message 117 within the Webkinz Flash environment at 110 and not open a new browser window. The warning page can include a warning that the user is departing the Webkinz or other website to visit the estore, which is a commercial site intended for adults aged 18 or older. An example warning page is shown as 200 in FIG. 2, providing the user with the opportunity to proceed.

The warning message 115 has an option to proceed at 205 and another to remain in the Webkinz world at 210.

If the user selects to proceed, system will open a new browser window and enter the eStore at 120 of the flow diagram in FIG. 1.

If the user selects not to proceed, system proceeds according to 125, thus closing the warning message and returning to the most recent active screen that the user was in the Webkinz world.

The system will display a different landing page at 125 when a user enters the Ganz eStore and the user is a Tier 1 user, and the user has clicked on a link to enter the eStore that was provided to them when they clicked on a locked item. In other words, when the user attempts to gain access to a portion of the website that is restricted by the lock, the computer system can automatically redirect the user to the landing page of the estore shown in FIG. 4. Redirecting the user in this manner is an attempt to persuade the Tier 1 user to purchase a virtual item from the estore and convert that Tier 1 user to a full member.

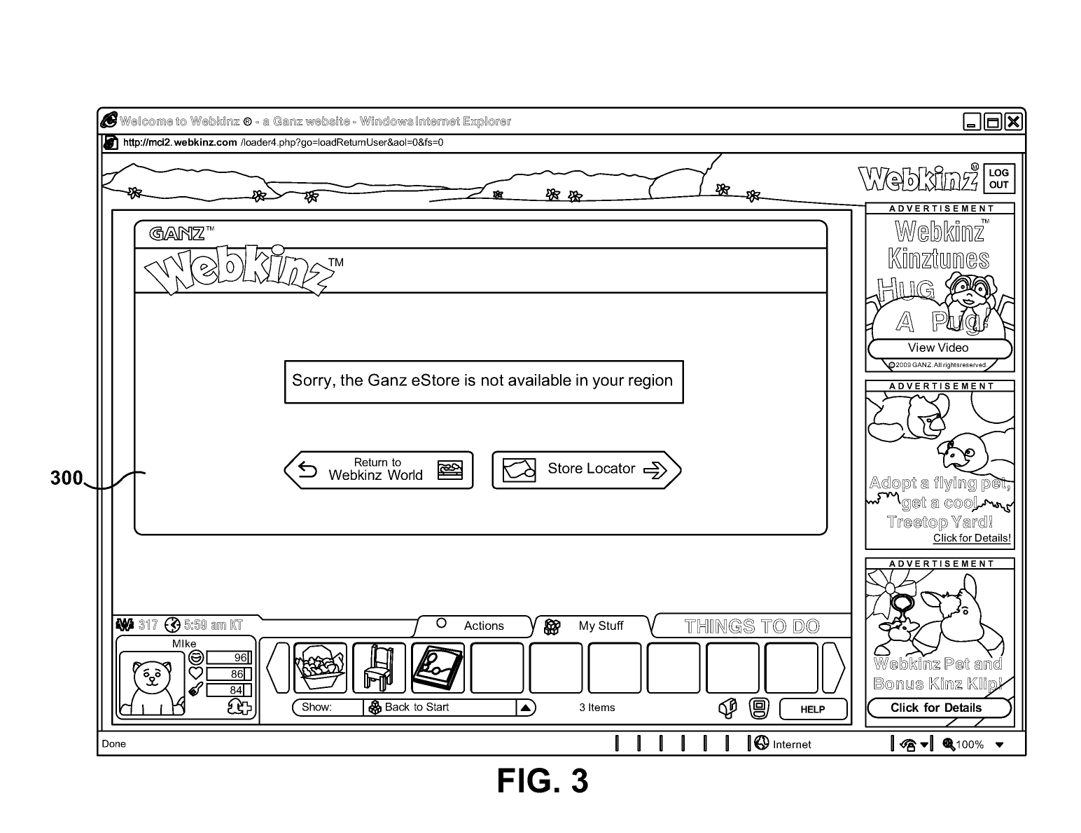

The system may also require that the geographic IP for the user is from a country where the eStore is in business. FIG. 3 shows a screen as 300 that may be shown if the user is outside the authorized geographic region, showing that the estore is not available in that region.

The landing page as shown in FIG. 4 is a straightforward page which includes 6-15 Webkinz pets such as Brown Cow 400 and their respective purchase prices such as the price 410 of $15.00. For the illustrative embodiment shown in FIG. 4, the following pets are displayed, but other pets and virtual items other than virtual animals are also contemplated:
Brown Cow
Koala
Horse
Golden Retriever
Collie
Chihuahua
Persian Cat
Pink Google

As shown in FIG. 4, some of these items may be offered as a package along with special virtual items that are usable on the website. For example, the Chihuahua 440 may be packaged with two special items which shows a special throne 445 in which the Chihuahua can sit. Special food 446 that the Chihuahua can eat is also shown. Purchasing the items that are packaged with other items provides the user with both the purchased items, and the other items. Thus, a Tier 1 user who purchases the Chihuahua 440 also receives the virtual throne 445 and special food 446 at no cost in addition to the $15.00 purchase price shown.

During a transaction involving the purchase of a virtual item from the limited version of the estore by the Tier 1 user, the system can require and prompt the Tier 1 user to establish login information and create a user profile. The system can also remembers the user's Tier 1 login information at this point, including their user name and the password, so the user can save any progress made during a visit to the website, such as purchasing and adopting the virtual pet. The user profile also includes an indication that the user has become a full member following the purchase of the virtual pet from the estore according to the one click protocol.

Selecting the Pets

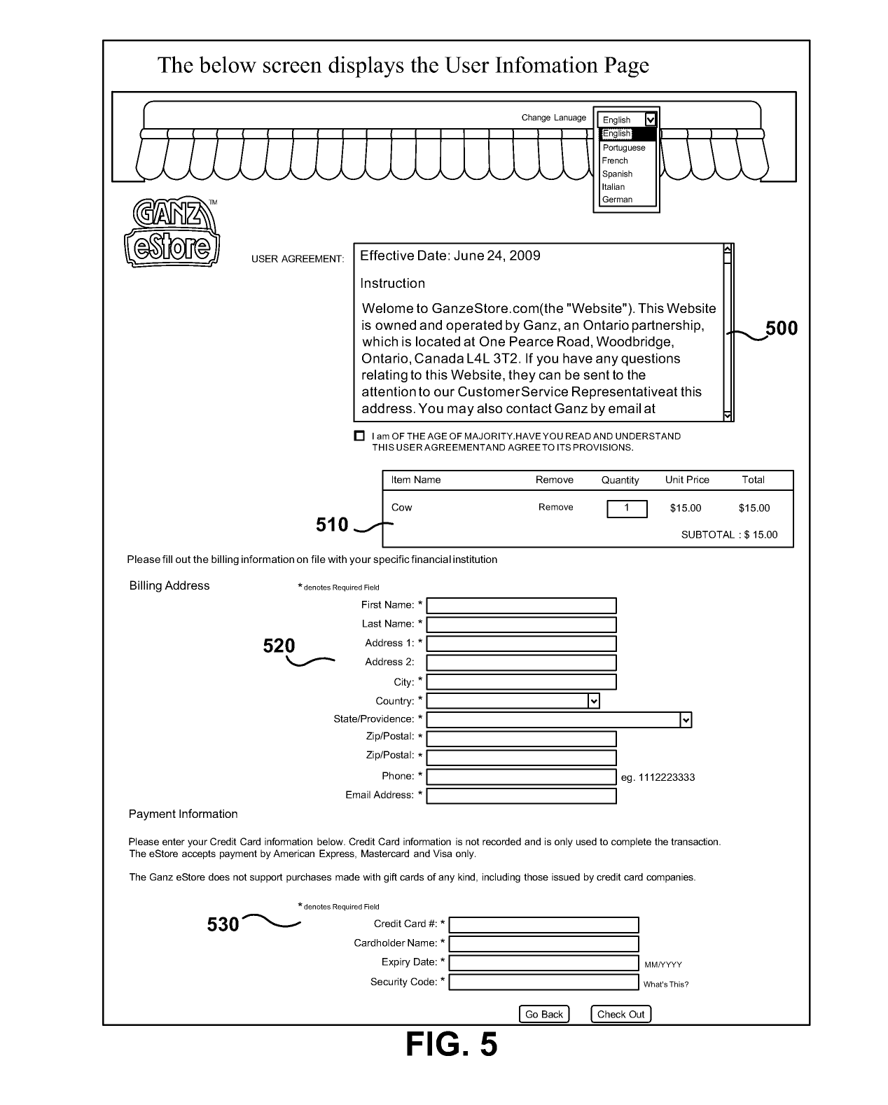

The system allows Tier 1 users to select a pet by clicking on it at 130. At that point, the system assumes that the user intends to purchase the pet, and automatically redirects the user in response to clicking on the pet to a payment page at 135. An illustrative embodiment of the payment page in FIG. 5, shows the user agreement 500, a checkout box 510, billing information 520 and payment information 530. The system displays the selected pet, the purchase price, taxes on the payment page and the grand total of the purchase price on the payment page.

The system also displays a legal disclaimer, terms and conditions and a user agreement for making a purchase on the site. The computer system can optionally require the user to indicate that the user has read and agreed to all conditions stated on the website by executing a check box 505, which can be deselected by default, requiring an affirmation by the user to select the check box 505. The computer system allows users to enter their mailing address & credit card details on the payment page, without having to sign up for an account, as shown at 140 of FIG. 1.

Once the check box 505 has been checked and all credit card information filled in, system activates a “Check Out” button 535 to enable the user to proceed with the purchase.

Once the “Check Out” button 535 has been selected from on and all the above criteria met as detected at 145, the system automatically creates and registers the account for the user at 150.

The system displays a confirmation page of the purchase at 155. This page has a summary of all purchases, taxes, the total amount and credit card information.

The system also informs the user that the purchase is final and no refunds or exchanges are available.

System ensures that the user has read and is aware of the refund policy with the help of a check box; the check box can once again be deselected by default.

Once the user has selected the check box to confirm the transaction at 160, system processes the transaction at 165 to complete the order. The determination of the transaction being approved at 170 causes the system to generate a pet code and e-mail the newly-generated pet code to the user at 175. A pet code is uniquely indicative of the specific item for sale, and comprises a code that can only be used once to obtain only one item.

The system sends an email confirmation to the user as a receipt and proof of payment.

System also sends an email to the user, with information regarding the generated pet code for the pet. The information regarding the generated pet code can optionally be included in the email confirmation.

System Temporarily Saves the Pet Code

The code is saved until the browser session is ended.

If the transaction is unsuccessful, system must gives an error message to the user at 180 and asks the user to check the entered payment information and try again.

Redirect to Adoption Center

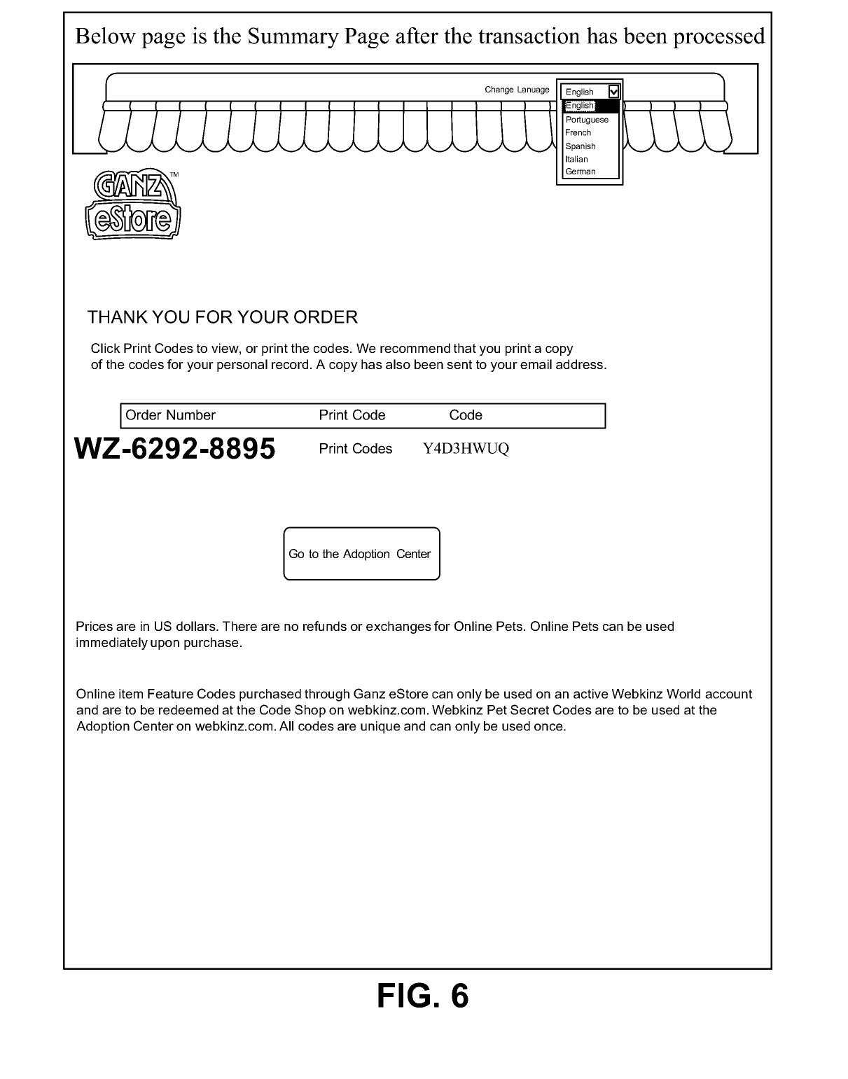

After a purchase has been successful and the system has displayed the pet code to the user, the system provides an option to the user to go into the adoption center at 185. An example of a summary page is shown in FIG. 6, and includes an adoption button 600 that, when selected, directs the user to the adoption center. The adoption Center for example can be the place in which the users can enter various information about their virtual pet.

In response to selection of the adoption button 600, the system reactivates the Webkinz window and opens the adoption center for the user.

If the Webkinz window has been closed or the user has logged out, the system opens a new window prompting the user to log in prior to directing the user to the adoption center.

Upon login, the system directs the user directly into the adoption center.

The landing page will change when the user has been directed to the adoption center from the eStore after a purchase has been successful. The system will auto populate the saved pet code into a text entry field where the code is to be entered to be submitted for validation and registration purposes when user reaches the “enter pet code” step in the adoption process.

All pages in the eStore will have a language drop down menu 420 (FIG. 4) at the top right corner, which will enable the user to change their language to one of the following:
English
French
German
Spanish
Portuguese
Italian

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other virtual items can be used in this sytem.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form. The computer system may include one or more sub-systems for performing various portions of the methods described herein.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PC1”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory su.ch as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
hosting a website on a server, where said website comprises a plurality of different interactive activities to be performed by users on the website, said plurality of interactive activities including interacting with virtual items on the website;
storing user profiles on the website, for the users of the website, where said users include a first set of users who have paid for membership access to the plurality of multiple different interactive activities on said website, and said users also include a second set of users who are free users who have not paid for access, and where said first set of users obtain access to fewer activities on said website than said first set of users;
granting access to an electronic store associated with said website, such that when members of said first set of users who have paid for membership access request to visit said electronic store, said members of said first set of users are presented with an expansive selection of items available to be purchased, and when members of said second set of users who have not paid for access request to visit said electronic store, said members of said second set of users are presented with a limited selection of items available to be purchased, where a number of said items in said limited selection is less than a number of said items in said expansive selection;
converting said free users who purchase a desired item selected from the limited selection of items into additional members of said first set of users; and
subsequent to said converting, granting the additional members of said first set of users said membership access to the complete selection of items in response to a request by said additional members to visit said electronic store.

2. A method as in claim 1, wherein said free users receive only a single page which has a first selection of items for sale that has only said limited selection of items, and said free users are only allowed to purchase one of said items for sale, and not allowed to do anything other than purchase said one of said items for sale.

3. A method as in claim 2, wherein said items offered for sale as the limited selection of items are virtual pets.

4. A method as in claim 3, wherein said virtual pets have different looks, representative of different animals.

5. A method as in claim 2, wherein the limited selection includes at least one base item offered for sale in combination with at least one additional virtual item for use on the website, wherein when the base item is purchased the at least one additional virtual item is included in the purchase at no additional cost.

6. A method as in claim 2, wherein sales of said limited selection of items comprise transmitting a special code that is uniquely indicative of each purchased item selected from the limited selection of items.

7. The method as in claim 1, wherein said converting comprises:
providing the members of the second set of users who purchase said one or more items selected from the limited selection of items with information in response to purchasing said one or more items selected from the limited selection;
receiving said information over a communication network;
validating said information; and
in response to successfully validating said information, updating a status of said members of said second set of users who purchase said one or more items selected from the limited selection in said user accounts to said additional members of the first set of users.

8. The method as in claim 1, wherein said converting occurs automatically in response to the purchase by said members of said second set of users from the electronic store.

9. The method as in claim 1, wherein said second set of users are free users who have not paid to access said website and said first set of users are full members who have paid for said membership access to said website.

10. A computer system that hosts a website comprising a plurality of interactive activities that a user can interact with using a virtual character, the computer system comprising:
a server subsystem serving content, via the Internet, to allow remotely-located user computers to display the website to users accessing the website via the user computers;
an account subsystem that maintains user profiles for paid membership users who have paid to acquire a membership to the website, wherein said paid membership users are granted access to the plurality of interactive activities on said website and free users that are not paid membership users are granted limited access to less than all of the plurality of interactive activities that are accessible by said paid membership users;
an electronic-store subsystem for hosting an electronic store offering for sale virtual items for use on the website, where said paid membership users are granted access by said electronic-store subsystem to a paid user version of the electronic store offering an expansive selection of said virtual items for sale, and said free users are granted access by said electronic-store subsystem to a limited user version of the electronic store that offers fewer of said virtual items for sale than the paid user version of the store, where said electronic-store subsystem limits the limited version of the electronic store to present users with a single view of said virtual items for sale in the limited version of the electronic store, to be purchased by said free users without allowing the free users to see any additional view of said virtual items in the limited version of the store, other than said single view, prior to purchasing said virtual items from the limited version of the electronic store, where said free users are only allowed to purchase one of said virtual items from the limited version of the electronic store and are not allowed to do anything in the limited version of the electronic store other than purchase said one of said virtual items for sale, and where said paid user version of the electronic store allows the users to view other views of said virtual items other than said single view prior to purchasing,
and where said account subsystem indicates in a user profile for said free users who purchase an item from said limited version of the electronic store that said free users have become said paid membership users with access to said paid user version of the store.

11. The computer system as in claim 10, further comprising an adoption subsystem which allows users to adopt a virtual item, and where said second set of users comprises users who have not yet adopted the virtual item.

12. The computer system as in claim 11, wherein said members of said second set of users who purchase said virtual item from said limited version of said electronic store are automatically directed to said adoption center in response to purchasing said item.

13. The computer system as in claim 10, wherein said purchase of said virtual item from said limited version of said electronic store is carried out according to a one click protocol.
